(19) United States
(12) Patent Application Publication
(10) Pub. No.: US 2012/0150760 A1
(43) Pub. Date: Jun. 14, 2012

(54) SYSTEM AND METHOD FOR VERIFYING EMPLOYMENT ELIGIBILITY

(76) Inventors: Marguerite T. Barrett, South Windsor, CT (US); Maria Q. Fazzino, South Glastonbury, CT (US); Frederick John Melkey, Granby, CT (US); Omar J. Rivera Torres, Windsor, CT (US)

(21) Appl. No.: 12/967,887

(22) Filed: Dec. 14, 2010

(51) Int. Cl. G06Q 10/00

(52) U.S. Cl. 705/321

(57) ABSTRACT

An employment eligibility verification system is provided which includes an employee database, for storing a plurality of employee records each record having data associated with an employee including an employee hire date and an employee hire status[MTB1], a verification processing system for receiving information associated with at least a first employee record from the employee database and for triggering the initiation of an employee verification process based on at least one of the employee hire date and the employee hire status, the employee verification process including the notification of at least a first attestor to gather employee verification data associated with the at least first employee record. An interface module is provided to receive employee verification data and for submitting employee verification data to a remote verification entity for verification processing. The interface module further receives a verification response from the remote verification entity based on the verification processing. The verification processing system is configured to update the employment eligibility status based on the verification response and to generate at least a first workflow notification based on a result of the verification processing.

### FIELD

The present invention relates to computer systems and more particularly to the use of computer systems and methods for the verification of employment eligibility and compliance.

### BACKGROUND

Many jurisdictions, including the United States, increasingly require employers to verify the employment eligibility and identity of new employees to ensure that only individuals who may legally work in the jurisdiction be employed. For example, in the United States, employers may only employ individuals who may legally work in the United States—either U.S. citizens, or foreign citizens who have the necessary authorization. Employers comply with this requirement by completing an Employment Eligibility Form (the “I-9” form). Proper completion of these forms is essential, as fines may be imposed for not completing the form or for completing the form improperly. For employers that hire a number of employees, ensuring proper and accurate completion can be difficult.

Further, some employers in the United States use an electronic eligibility system (referred to as the “E-Verify” system) to determine the eligibility of their employees to work in the United States. The E-Verify system allows certain employers to electronically submit employee data to the Department of Homeland Security and other Federal Agencies for verification. The E-Verify system provides an interface for receiving such data, but does not provide any controls or mechanisms to ensure that data is collected properly and without error. Further, the E-Verify system does not provide for the control of the resolution process when a “tentative non confirmation” (or “TNC”) is issued by the system, or to control the investigation and resolution of other issues relating to the verification process. Further, existing systems do not provide for the control or processing of subsequent verification events that may occur after an employee's eligibility is verified. It would be desirable to provide systems and methods which provide improved data collection and processing of verification data, as well as to provide improved control and management of resolution, investigation and post hiring processes.

### SUMMARY

In general, and for the purposes of introducing concepts of embodiments of the present invention, a system for the verification of employment eligibility is provided which includes an employee database, for storing a plurality of employee records each record having data associated with an employee including an employee hire date and an employee hire status, a verification processing system for receiving information associated with at least a first employee record from the employee database and for triggering the initiation of an employee verification process based on at least one of the employee hire date and the employee hire status, the employee verification process including the notification of at least a first attestor to gather employee verification data associated with the at least first employee record. An interface module is provided to receive employee verification data and for submitting employee verification data to a remote verification entity for verification processing. The interface module further receives a verification response from the remote verification entity based on the verification processing. The verification processing system is configured to update the employment eligibility status based on the verification response and to generate at least a first workflow notification based on a result of the verification processing.

Pursuant to some embodiments, systems, methods and processes for verifying employment eligibility of an employee are provided including operating a verification processing system to trigger an employee verification process based on information associated with the employee, notifiying at least a first attestor operating an attestor device of the employee verification process for the employee. The notifying including generating at least a first message by the verification processing system. The verification processing system further generating a series of data entry screens for display on the attestor device, the series of data entry screens generated based on information associated with the employee and based on a employee hire status of the employee. Verification data associated with the employee is received from the attestor device in response to the series of data entry screens, and the verification data is transmitted to a remote verification entity. A verification response is received which causes the initiation of at least a first workflow notification by the verification processing system.

Pursuant to some embodiments, a hiring system is provided which is in communication with at least one of the verification system and an employee database to provide employee data resulting from a hiring process.

In some embodiments, an I-9 compliance module, associated with the verification processing system, is provided for generating a sequence of user interfaces for display on an attestor device operated by the at least first attestor to receive employee verification data, the sequence of user interfaces generated based on the employee data and including at least a first user interface prompting an employee to enter birthdate authentication data, the birthdate authentication data compared to the employee birthdate from the hiring system.

In some embodiments, an external verification module is provided for receiving employee verification data from the I-9 compliance module and for transmitting the employee verification data to a remote verification entity for verification processing and further for receiving a verification response from the remote verification entity based on the verification processing.

With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram that illustrates a computer system provided in accordance with aspects of the present invention.

FIG. 2 is a flow chart that illustrates an employment verification process that may be performed in the computer system of FIG. 1.

FIGS. 3A-3I shows example screen displays that may be provided to user computers to allow interaction with the system of FIG. 1.

FIG. 4 is a flow chart that illustrates a verification resolution process that may be performed in the computer system of FIG. 1.

FIG. 5 is a block diagram illustration of a typical one of the application server computers shown in FIG. 1.

### DETAILED DESCRIPTION

Embodiments of the present invention may be beneficially used in a number of different regulatory environments. However, in one currently preferred embodiment, the invention is provided for use in (1) ensuring that an employer complies with requirements to verify an employee's identity and to establish that the worker is eligible to accept employment in the United States (by proper completion of an Employment Eligibility Verification Form or “I-9”), and (2) for submitting (where required) employment eligibility verification data to the United States Department of Homeland Security (“DHS”) via their Employment Eligibility Verification system (“E-Verify”).

Embodiments allow the efficient and accurate collection of employee data, compliance with I-9 requirements, and the submission of data from the electronic I-9 forms to the DHS via the E-Verify system operated by the DHS. The E-Verify program provides an electronic interface and specification for the transmission and receipt of I-9 data from employers. However, the E-Verify system does not provide any specification, code or documentation relating to how an employer identifies, tracks, or collects the data. Embodiments allow employers to identify, track and collect data needed for compliance with I-9 obligations as well as for submission to the E-Verify system.

For example, features of the present invention have allowed an employer using the invention to reduce data entry errors by more than 50%. Embodiments achieve this, in part, by providing a structured data collection and entry system enforcing consistent data collection by a widely distributed work force. By reducing data entry errors, the incidence of “technical violations” which can carry a fine of between $110 and $1100 per violation are significantly reduced. In addition, the incidence of “tentative non confirmation” (or “TNC”) responses from the E-Verify system (and other errors) are significantly reduced, thereby reducing the cost and effort required to correct and respond to TNC and other errors. Further, embodiments allow an employer to accurately and efficiently schedule, administer and enforce the completion of any required subsequent verification activities (such as those related to employees requiring re-verification due to work Visas or the like. Embodiments allow the efficient management, scheduling and processing of such subsequent verification activities.

These, and a number of other advantages and features of the invention, will become hereinafter apparent. Embodiments of the present invention may be more clearly understood by reference to the following detailed description of the invention, the appended claims, and the drawings attached hereto.

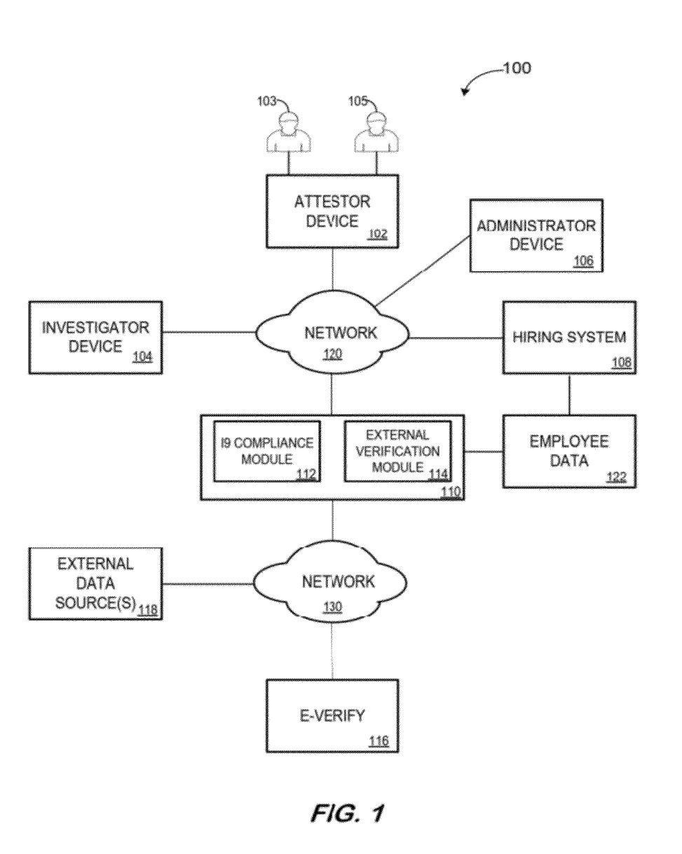

FIG. 1 is a block diagram that illustrates a computer system 100 provided in accordance with aspects of the present invention. The computer system 100 may be an enterprise system that is suitable for handling data processing needs of a large organization. A number of networks, application servers and devices may comprise the system 100, including networks, application servers and devices that are controlled by multiple entities. For the purposes of illustrating features of some embodiments, an example operating scenario will be provided. In the example scenario, a large employer wishes to utilize features of the present invention to manage, administer and perform employee verifications. The large employer has a distributed work force with locations around the United States. The employer is required to complete I-9 verification documents and then submit employee verification information to one or more Governmental entities for confirmation. Some of the networks, application servers and devices shown in the system of FIG. 1 are operated by or on behalf of the large employer, and some are operated by or on behalf of third parties (including the one or more Governmental entities). This illustrative example will be continued throughout the remainder of this disclosure to facilitate a description of some embodiments of the present invention. Those skilled in the art, upon reading this disclosure, will appreciate that other operating scenarios or configurations may be used with desirable results.

The computer system 100 includes a number of types of components, including one or more application servers such as a verification processing system 110 and one or more government or third party verification systems, such as the E-Verify system 116 operated by the United States Department of Homeland Security (“DHS”). The verification processing system 110 may be operated by or on behalf of an employer to manage, administer and perform the processing of I-9 employee verification requests for employees of the employer. The processing of I-9 employee compliance is performed under control of one or more software modules or components of the system 110 (such as the I-9 compliance module 112). The system 110 may also control interactions with the E-Verify system 116 using one or more software modules or components (such as the external verification module 114).

Pursuant to some embodiments, data collected under the control of the I-9 compliance module 112 may be used by the external verification module 114 to ensure accurate and up to date employee verification data is transmitted to the E-Verify system 116. In some embodiments, both or each of the modules 112, 114 are implemented on a server system or network of computers associated with the system 110.

The E-Verify system 116 is the system operated by or on behalf of the DHS to perform the actual confirmation of employee data submitted from the verification processing system 110. The E-Verify system 116 receives data from (and provides response data to) one or more verification processing systems 110 through one or more networks 130. The verification processing system 110 may be implemented as a secure server or network of servers and operated by or on behalf of an entity that wishes to provide employee verification data to the E-Verify system 116 electronically. Pursuant to some embodiments, the verification processing system 110 includes one or more components to transmit verification data to the E-Verify system 116 in accordance with a Web Service protocol or application programming interface (“API”) specified by the E-Verify system 116. For example, in the situation where the verification processing system 110 provides I-9 data to the E-Verify system, the data transmitted to the E-Verify system 116 is in accordance with the API specified by the DHS for use with the E-Verify system 116. Response data received by the verification processing system 110 from the E-Verify system 116 may be provided in accordance with a similar (or the same) API or Web Service. Those skilled in the art will appreciate that other verification systems (other than E-Verify) may be used with the present invention.

Pursuant to some embodiments, the verification processing system 110 provides a number of features or components that ensure that the data that is collected and transmitted to the E-Verify system 116 is consistent and accurate. Further, the system 110 includes features or components that ensure that any response data received from the E-Verify system 116 is processed in a consistent, accurate and timely manner.

Pursuant to some embodiments, the verification processing system 110 accomplishes this by interacting with a number of devices, users and user devices, including hiring system 108, employee database 122, attestor devices 102, investigator devices 104, and administrator devices 106. Pursuant to some embodiments, when a new employee (such as employee 103) is hired by an employer, information about the employee is entered into a hiring system 108 and the data is stored in an employee database 122. The hiring system 108 may receive the new employee data directly from an employee application process or by data entry from an administrator or other operator. The employee database 122 stores information including the employee name, address, social security number (or other federal identification number), date of birth, date of hire, and, in some embodiments, an employee hire status (such as, for example, “external new hire”, “rehire” or “internal hire”). The data from the employee database 122 is made available to the verification processing system 110 and is used, in some embodiments, to trigger an I-9 process, or otherwise cause the identification of employees for which an I-9 process pursuant to the present invention is required.

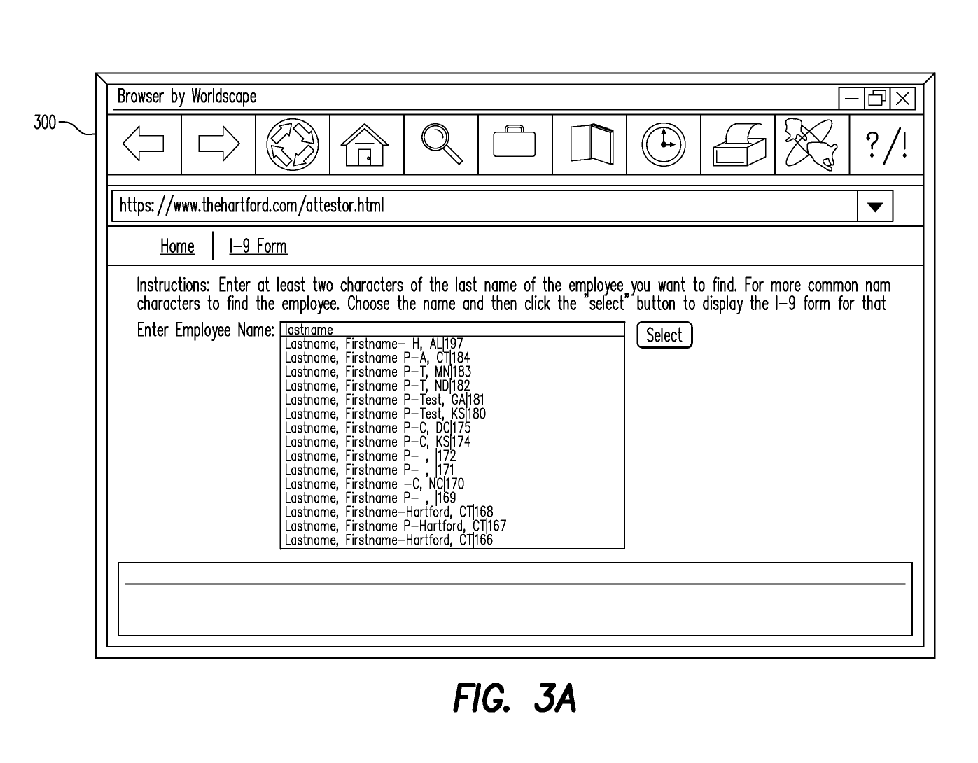

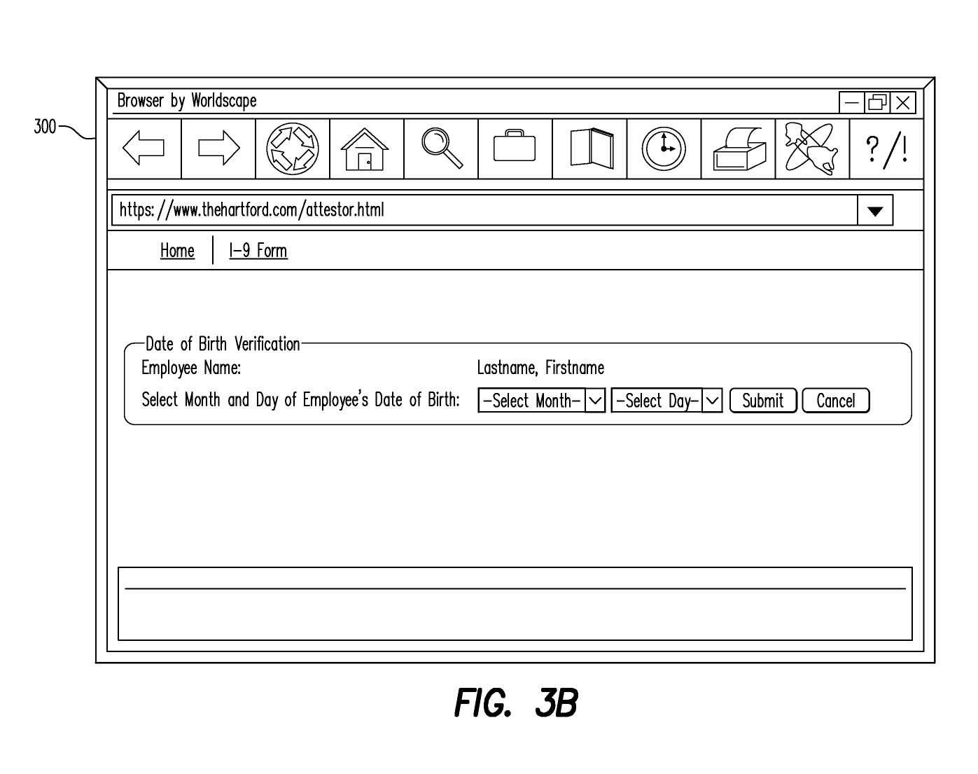

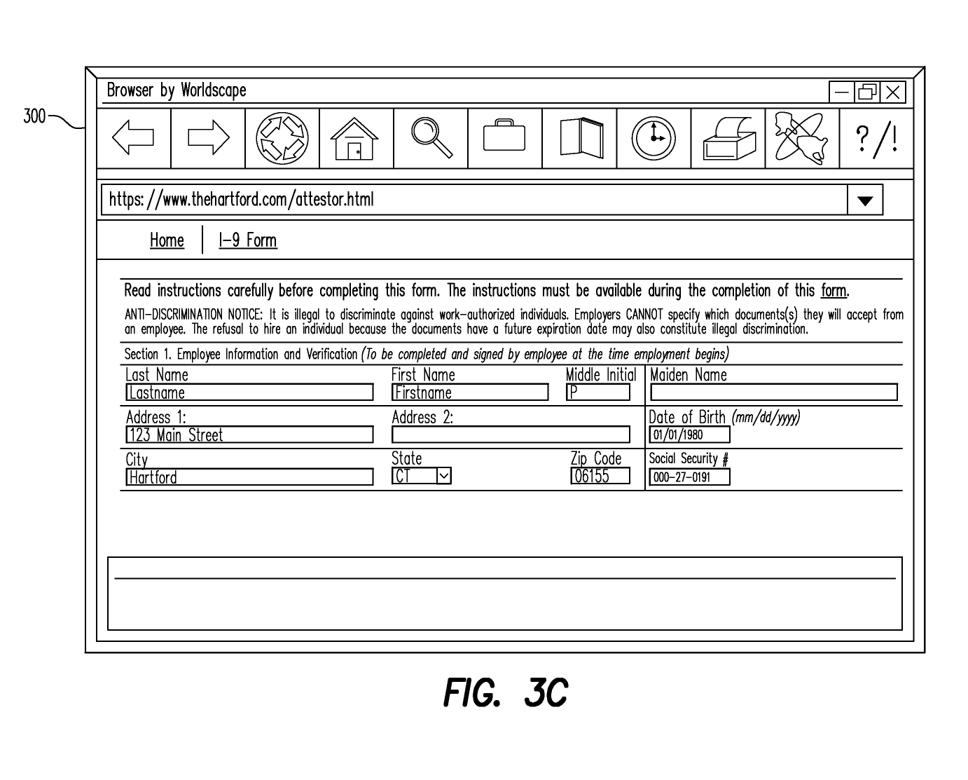

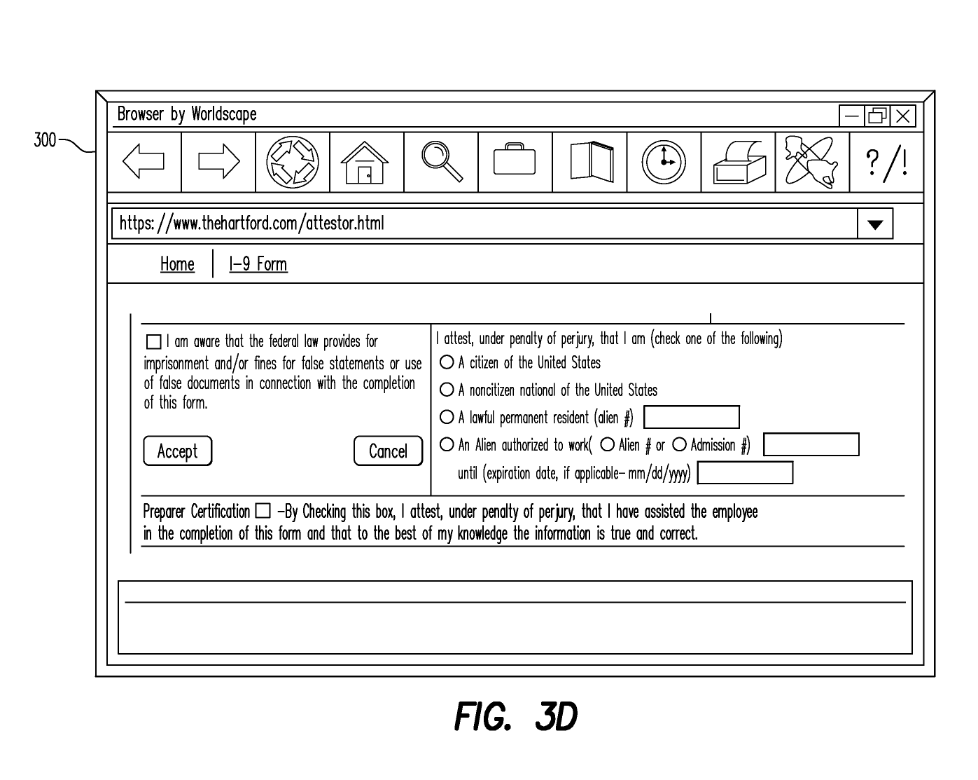

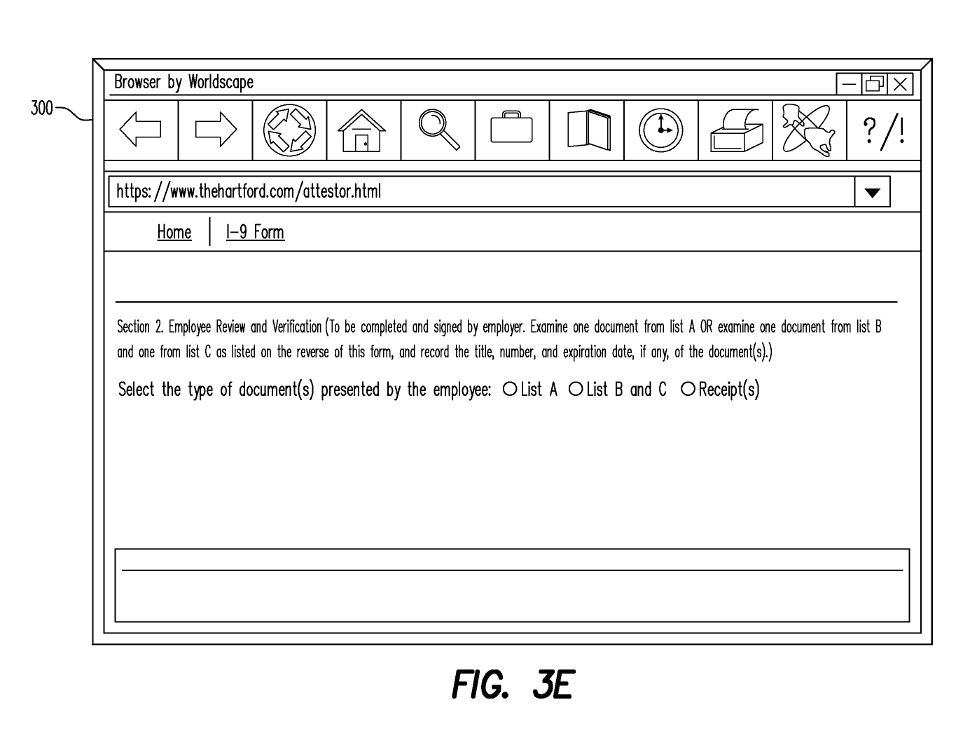

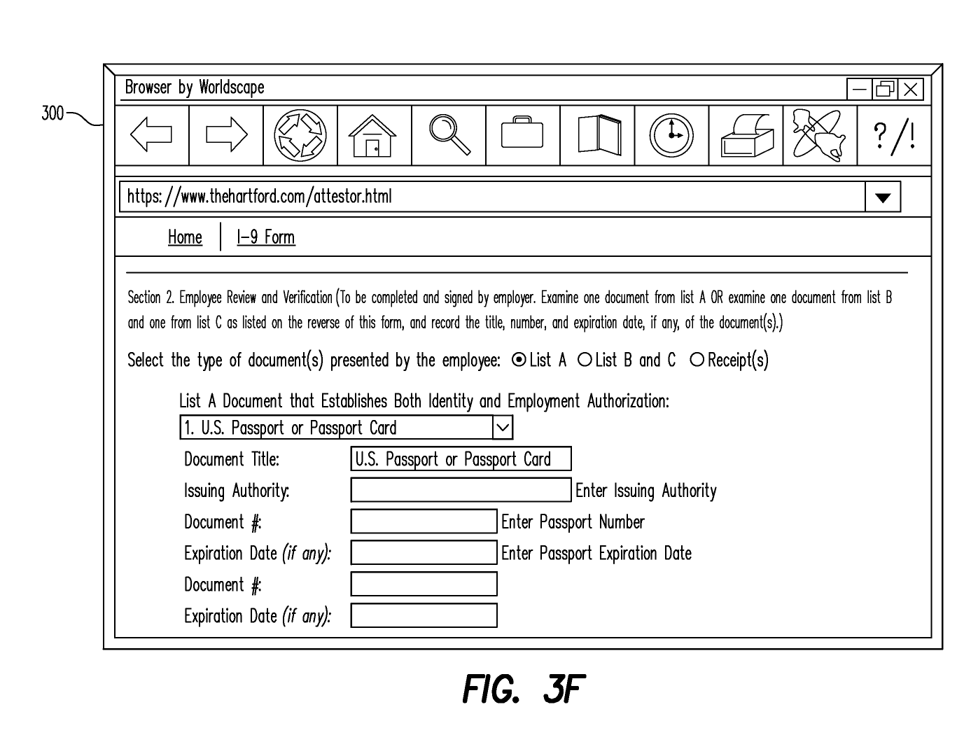

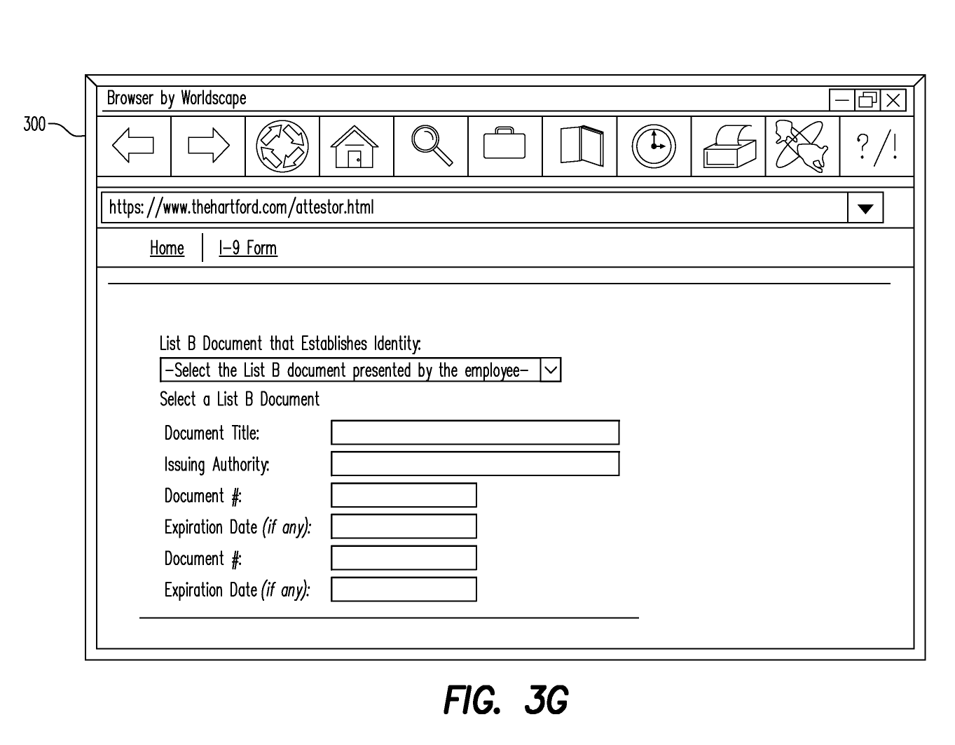

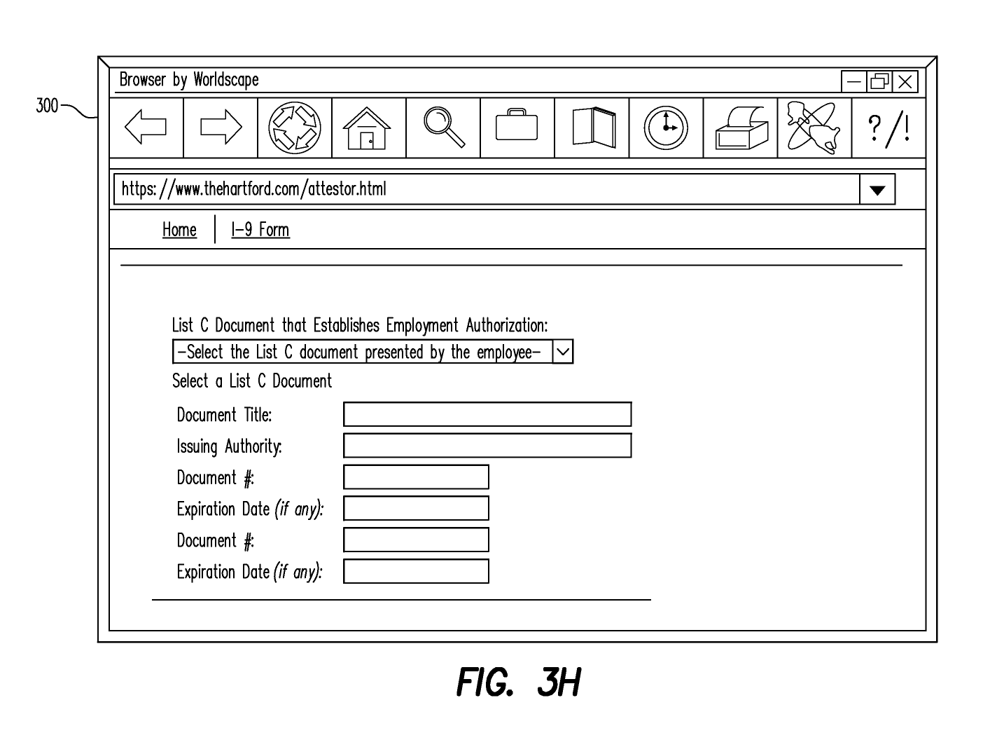

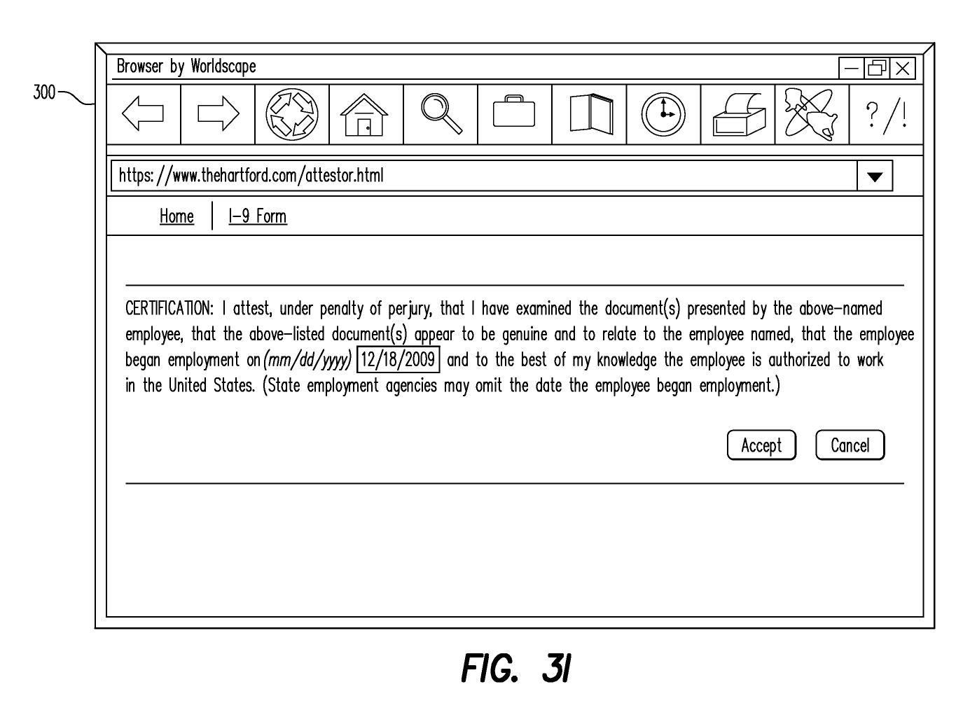

The attestor devices 102, for example, allow designated employees or agents of an employer (referred to herein as “attestors” and represented as attestor 105 in FIG. 1) to interact with an employee 103 to collect data (including information about the employees' identity and work authorization documents) and enter that information into the verification processing system 110. Further the attestor 105, interacting with the attestor device 102, provides the employee 103 with access to certain limited aspects or user interfaces of the verification processing system 110 so the employee can complete a portion of a form for submission to the verification system 110 (e.g., in the case where the form is an I-9 form, the attestor allows the employee to complete Section I of the I-9 form, e.g., as illustrated and described below in conjunction with FIGS. 3B, 3C and 3D). The attestor 105, operating the attestor device 102, then “attests” through an electronic signature process that the employee produced original, unexpired documentation and that the employee entered the required information into the appropriate fields (e.g., as illustrated and described below in conjunction with FIG. 31). The attestor 105, operating the attestor device 102, then views the original unexpired documentation provided by the employee 103 and enters the appropriate information from those documents to the verification system 110 as illustrated in FIGS. 3E and 3F. Further, pursuant to some embodiments, the verification system 110 is configured to ensure that the correct documentation required for a given employee is collected and entered properly, thereby significantly reducing data entry and collection errors. Further details and features of the attestor device 102 and the interaction between an attestor 105, an employee 103, and the verification processing system 110 will be provided further below.

The administrator device 106 allows users with administrative privileges to interact with, configure and control features of the verification processing system 110. For example, in some embodiments, administrators may interact with the system 110 to control the assignment of employee verification tasks to attestors 105 or investigators. Further, administrators may generate reports, manage workflow, and otherwise ensure that employee verifications are performed in an accurate and timely manner.

The investigator device 104 allows users with investigator privileges to interact with the verification processing system 110 to monitor, process and resolve verification matters that require additional investigation. For example, in the case where an I-9 has been submitted by an attestor 105 (through an attestor device 102) to the system 110, and the system 110 has transmitted an electronic I-9 record to the E-Verify system 116 and the E-Verify system 116 has responded with an error message (such as a TNC or other message indicating that the employment has not been authorized), an investigator may be assigned to take steps to resolve the error associated with the error message. Embodiments provide a controlled workflow and notification system for ensuring that investigators are promptly alerted to such situations and provided with sufficient information to resolve the matter where possible. Further details of the workflow and processing associated with investigator device 104 will be provided below.

Pursuant to some embodiments, the verification processing system 110 operates using data from one or more employee databases 122. For example, the system 110 may retrieve or access employee data from an employee data warehouse or database system on a regular or real-time basis. The employee data warehouse may be a payroll system or employee record keeping system which maintains data associated with newly hired employees as well as existing employees. For example, the verification processing system 110 may receive a feed or regular update of new hire data based on a flag or code indicating the employee hire status. As a specific illustrative example, the data may include new hire records that indicates whether an employee has an employee status of “new hire” or an “employee” who is required to pass an employment eligibility verification process. The criteria for determining whether an employee is required to pass an employment eligibility verification process may include rules that specify that all new hires must be verified using both an I-9 compliance process (under the control of module 112) and an external verification process (under control of module 114 in communication with the E-Verify system 116).

The data received from the employee database 122 is then processed by the verification processing system 110 to create a set of employee records for which verification is required. The system 110 then interacts with the attestor 102, investigator 104 and/or administrator 106 devices to ensure that those employees are verified using features of the present invention. Further information regarding the work flow and interfaces to perform such processing will be provided further below.

Pursuant to some embodiments, the verification processing system 110 may further transmit updated employee data to the employee data store 122 to ensure that the payroll and other employee records are up to date based on the results of the employee verification processing of the present invention.

The verification processing system 110 may also store criteria including rules specifying when certain existing employees require reverification (e.g., where the employee is working under a Visa or other work permit and an eligibility period is upcoming or has expired) under control of the I-9 compliance module 112. In some embodiments, the data used to determine when certain existing employees require reverification may be based on data stored in or accessible to the system 110.

The verification processing system 110 may further be in communication with one or more external data sources 118. For example, in some embodiments, verification of an employee may include retrieving information from external sources, such as State Motor Vehicle records (e.g., to confirm the validity of a new employee's driver's license), information from the Social Security Administration, or other data sources; these data sources would interface with system 110 through the system 114 interface. The external data sources 118 may be in communication with the system 110 through one or more networks 130 (e.g., such as the Internet or the like).

The application servers of the system 100 may be conventional in their hardware aspects, and in many of their software components. For example, the verification processing system 110 may be based on conventional server computer systems, allowing interaction with remote devices (such as attestor devices 102, investigator devices 104 and administrator devices 106, for example) using conventional communication protocols. As a specific example, the verification processing system 110 may be configured as a Microsoft Server or a Unix-based server. The devices, including devices 102-106 may be conventional Windows or Apple-based personal computers, and may depart from conventional operation only in terms of types of data entry and data collection techniques that those devices request, provide and display.

The verification processing system 110 and the user devices (102-106) may all be coupled to the data communication network 120 in a conventional manner to permit exchanges of data among the verification processing system 110 and the user devices 102-106. The verification processing system 110 will be described further below, but in its essential functioning, it stores and executes various application programs that provide to users employee verification and processing functions desired from the system 100. The devices 102-106 will also be described further below, but will be understood to be the conventional desktop and/or laptop personal computers of the types used by employees or agents of the employer organization. To some extent the devices 102-106 may function in a client-to-server role relative to server computers (such as the verification processing system 110) that are part of the system 100. Consequently, the devices 102-106 may also be referred to herein as client computers.

While the devices 102-106 are referred to using different labels (e.g., “investigator device”, “attestor device”, and “administrator device”), the labels generally relate to a specific use scenario. In some embodiments, the functionality which allows a device, such as an “attestor device”, to function as an attestor device is provided using a browser-based interface or a client application on a computer. In the situation where the functionality is provided through a browser, a computer may be used as both an “attestor device”, an “investigator device” and/or an “administrator device” based on how a user is logged in to interact with the verification processing system 110. For example, a single browser interface may be provided, allowing a user to interact with the verification processing system 110 in different ways depending on the user's privileges. A user having administrator-level privileges, for example, may utilize a computer to access and interact with verification processing system 110 as an “administrator” (and the computer they are using may thus be referred to as an “administrator device 106”). Pursuant to some embodiments, a user's privileges and access level may be defined using a single sign on process (e.g., where the privileges and access levels are defined and associated with their network access password and username). In this manner, employees or agents of an employer who are assigned responsibilities in the verification system may interact with the verification processing system 110 in a controlled manner. Further details regarding the privileges and responsibilities associated with different user levels and permissions will be provided below.

The verification processing system 110 operates to create employee verification records as well as user interfaces that prompt and direct users (such as attestors operating attestor devices 102) to collect and enter data for use in performing employment verification processing. A variety of screen displays and user interfaces are used to control the collection and submission of data. Examples of screen displays generated by the verification processing system 110 (and, e.g., displayed on devices such as attestor device 102, investigator device 104 and administrator device 106) are shown herein as FIGS. 3A-3I.

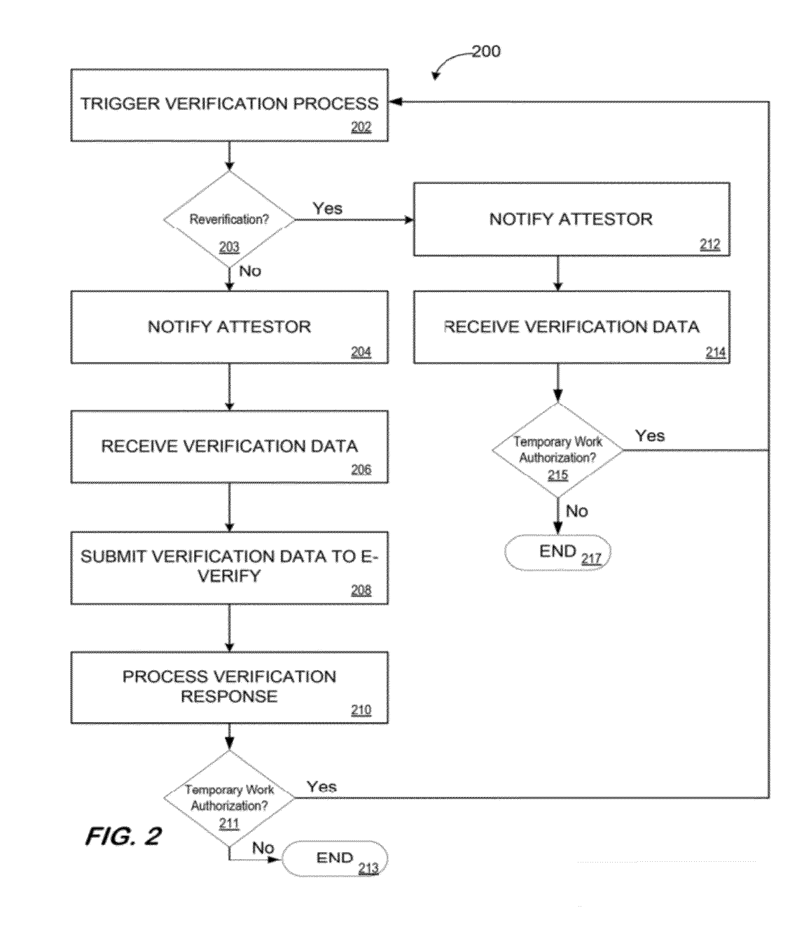

FIG. 2 is a flow chart that illustrates a employment verification process 200 that may be performed in the computer system 100 of FIG. 1 pursuant to some embodiments of the present invention. Employment verification process 200 may be performed under control of computer program code operated by verification processing system 110 and may include data transmission and processing in conjunction with other devices of systems 100.

Processing begins at 202 where the verification processing system 110 triggers a verification process. A verification process may be triggered in a number of different ways. For example, in a typical usage scenario, a verification process may be triggered based on the receipt of updated employee data from an employee database or data warehouse or verification system (such as employee data 122 or verification system 110). The updated employee data may include a feed or batch of new employees or employees who have a status change that may trigger a verification process (such as, for example, an employee's Visa or other work permit approaching an expiration date). The identification of employee data that triggers a verification process may be based on a tagging or coding scheme that causes one or more verification processing rules to be triggered based on the receipt of employee data. The processing or identification of such verification processing rules may be performed on a real time or scheduled basis as employee data is received. The result of the triggering of the verification process may be, for example, the creation of a new verification processing record in verification processing system 110. Each new verification processing record may include employee details and information associated with the employee, including a hire date, an office location, or the like. Pursuant to some embodiments, triggering the verification process may further have a time-based component. For example, new hires may be required to complete the verification process on the start date (or within a short time period after the start date). By using data provided from the hiring system 108, embodiments ensure that the verification process is triggered on the appropriate date.

Pursuant to some embodiments, in the case of a new hire verification, the data associated with a newly hired employee may be collected prior to the initiation of process 200. For example, in some embodiments, new employee data is provided to an employee database 122 via a hiring system 108. The new employee data may include a hire date as well as detailed information about the new employee (including name, address, etc.). The new employee data may also indicate an employee hire status. In some embodiments, the system 110 operates on the data received from the employee database 122 to identify those employees for which a verification process is required. At 203, a determination is made whether the verification process involves a reverification of an employee (e.g., such as a Section 3 reverification of an I-9 form, where an employee requires reverification processing to update a status of a work permit or the like). If it is a reverification, processing continues at 212 and 214 where an attestor is notified (similar to the notification described below in conjunction with 204) and the reverification data is received (using processing similar to that of 206). In the case of a reverification, no data is transmitted to E-Verifiy (instead, the reverification data is stored and processed by the verification processing system 110). Processing continues to determine if a temporary work authorization is involved at 215. If a temporary work authorization is involved, then processing returns to trigger a verification process at 202. If not, such as if a status of permanent residency is achieved, then the process may end at 217.

If it is not a reverification, processing continues at 204 where verification processing system 110 causes a notification to be transmitted to one or more attestors, notifying the attestor(s) that they have been assigned an employee verification record for processing. Attestors may receive a notification via an email notification, or by updating a queue or listing of assigned tasks in a dashboard or workflow management system.

In some embodiments, an employer may have a number of different individuals assigned the role of “attestor” and having access to an attestor device. When an attestor is assigned an employee verification task (e.g., upon receipt of a notification in step 204), the attestor meets with the employee and together the employee and the attestor provide employee verification data by entering data into a user interface for submission to the verification processing system 110 (and for transmission to the E-Verify system 116). A sample series of user interfaces that may be displayed to an attestor 105 are shown in FIG. 3. The attestor 105 first locates an employee's verification record by searching for the employee's name (as shown in FIG. 3A). Once the correct employee record is located, the attestor 105 selects it and a further screen (shown in FIG. 3B) is displayed, where the employee 103 is requested to “logically associate” themselves in the application by entering the month and day of their birthdate (as shown in FIG. 3B). This ensures that the employee 103 is entering verification information for the appropriate record, and ensure that embodiments meet the U.S. Federal Regulations relating to electronic signatures. In some embodiments, processing may not proceed until this logical association is performed. In the event the employee cannot provide the correct verification information, an override process may be performed (e.g., by the attestor 105 contacting an administrator or the like).

Upon successful verification of the employee by the logical association, the process continues and the employee 103 is then prompted to enter, review and update (if needed) information from Section I of the I-9 form. A screen such as the screen shown in FIG. 3C is displayed on a display terminal of the attestor device 102 and the employee 103 reviews the information and makes any needed updates. Once the information is provided, system allows the user interface interaction to proceed to the screen shown in FIG. 3D. In the sample user interface of FIG. 3D, the employee 103 is prompted to attest to their current status, (e.g., “citizen of the United States” or the like) and electronically “accept” or confirm that the information is correct. The attestor 105 is also prompted to certify that the information provided was accurate (to the best of their knowledge). Based on the selection of the employee's status, further user interfaces are automatically selected for display to the attestor and employee such that only information relevant to a selected status is requested. For example, if the employee indicates that he or she is a U.S. citizen, further screens prompting for information verifying that citizenship are generated (and screens relevant to a status of resident alien are not generated for that particular employee). By generating screens based on an employee's status, and limiting the choices available to the attestor 105 and employee 103, data entry errors and confusion are reduced.

The attestor 105 again is required to enter information, and a series of screens (starting with FIG. 3E) is presented to the attestor 105 (on a display device of the attestor device 102) prompting the attestor 105 to begin gathering and reviewing the employee's identity and work authorization documents. Different combinations of documents may be required depending on the employee's situation and status. In particular, depending on the employee's stated citizenship or immigration status (provided by the employee in Section I of the I-9 form), the attestor 105 will be presented with different drop-down lists of acceptable verification documents. In this manner, accurate collection and entry of data is improved.

Embodiments of the present invention ensure that the attestor 105 collects and reviews the correct documents for each employee 103, substantially reducing data entry and verification processing errors. Each attestor 105 and employee 103 is prompted to provide the correct set of documents based on each employee's situation. For example, the prompts begin at FIG. 3E, where a user interface for display on a display of the attestor device 102 is shown in which the attestor 105 is prompted to identify whether documents from “List A” or “List B and C” are to be provided. A further screen is displayed (such as the screen shown in FIG. 3F) if the attestor 105 indicates that documents from “List A” are to be used. A set of authorized document options is then presented in a drop down (e.g., such as “U.S. Passport or Passport Card”) along with the details to be provided from the selected document; the list of options available in the drop-down menu is determined by the citizenship or immigration status the employee 103 indicated in Section I of the I-9. Each user interface for a particular document type has different prompts and data entry options, ensuring the correct information is collected and entered for each authorized document type. Similar drop down lists and data entry screens are provided for “List B” and “List C” type documents (as shown in FIGS. 3G and 3H).

Once the attester 105 has entered the document information into the forms for either “List A” or “List B and List C”, the attestor 105 is prompted (by a display on a display device of attestor device 102 as shown in FIG. 31) to electronically sign the form by verifying the attestor 105 has reviewed the original documents presented by the employee 103, that the documents appear to be genuine and verifying the employee's date of hire in a certification statement and by submitting the data. Pursuant to some embodiments, the date of hire is pre-populated in the form from information collected from the employee database 122 (e.g., in step 202).

Once the attestor 105 has submitted the form, the employee verification data is transmitted to (or saved in) the verification processing system 110 (step 206 of FIG. 2). The verification processing system 110 then is operated to submit (at 208) the verification data to the E-Verify system 116. For example, in some embodiments, employee verification data is collected and then batch transmitted from the system 110 to E-Verify on a regular basis (e.g., such as hourly, daily, or as needed). In some embodiments, the employee verification data may be transmitted to the E-Verify system 116 substantially in real time (e.g., at the time it is submitted). In such embodiments, any response data received from the E-Verify system 116 may be displayed to the attestor 105 while he or she is still speaking with the employee 103, allowing more prompt resolution of certain types of errors or responses. In general, processing at 208 includes the verification processing system 110 electronically transmitting the employee information to E-Verify, which will compare the information with that contained in the Social Security Administration and Department of Homeland Security databases.

Processing continues at 210 where the verification processing system 110 receives a verification response and processes that response. For example, a response may include one of three response types: (1) “Authorized” (where the information submitted at 208 matches data available at the verification entities, and where no further action is required), (2) “Pending” (where the verification is still in process), and (3) “Tentative Non-Confirmation (TNC)” (where a data mismatch has occurred).

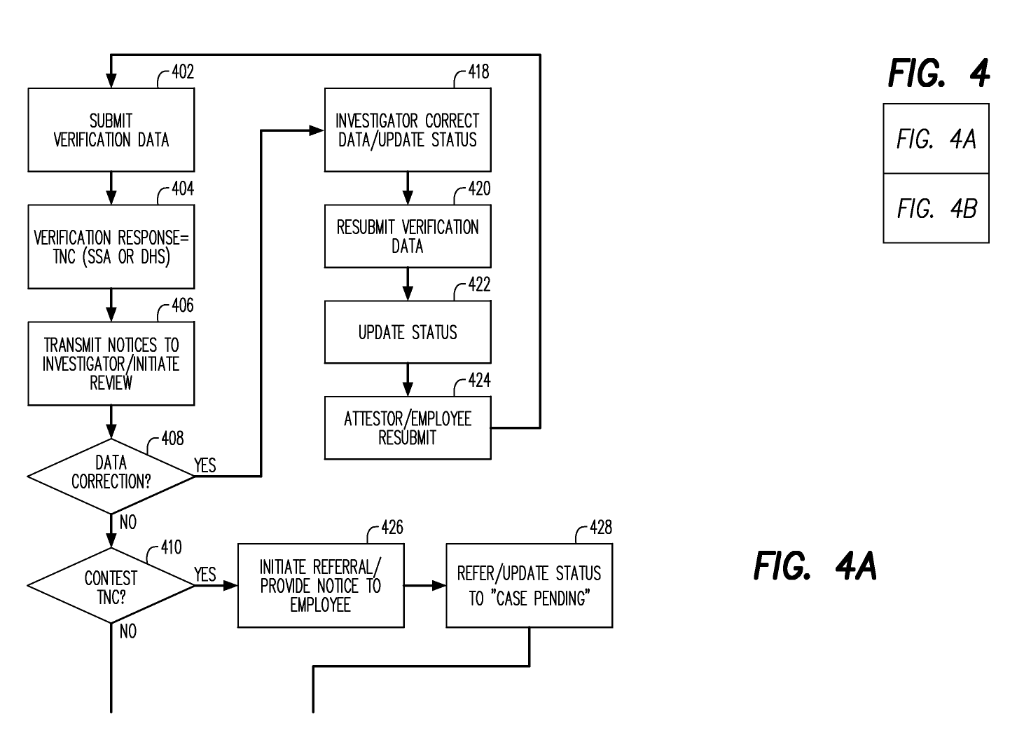

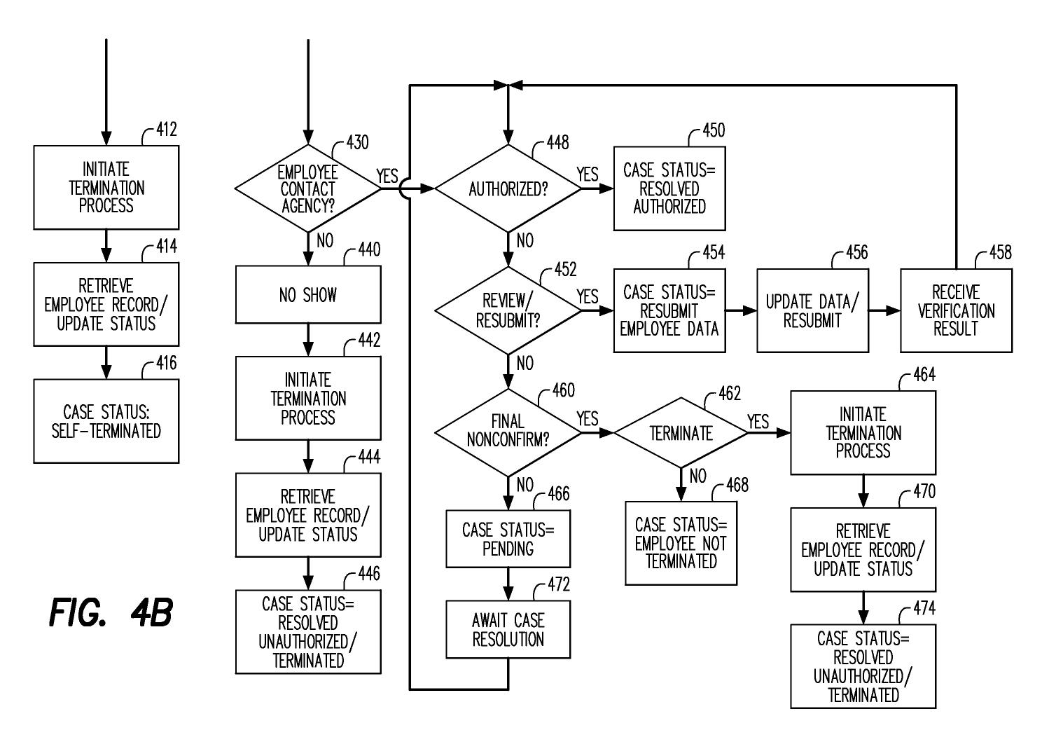

The subsequent processing performed by the system 110 will depend on which of the three response types is returned. For example, in the case of an “authorized” response, no further processing is required, and the employee is successfully verified and employment may commence. Data may be transmitted to the employee database 122 indicating the successful verification. In the case of a “pending”, the employee verification record at the system 110 may be updated with a pending status so that further response data may be matched or monitored. In the case of a “TNC” response, the system 110 may cause a notification to be transmitted to the employer's Human Resources department (or to a specific investigator assigned to the matter) to perform a follow-up investigation to resolve the TNC, where appropriate. Processing to resolve or respond to TNC responses will be described in further detail by reference to FIG. 4 and FIG. 5 below.

In the event that an “authorized” response is received, a verification number may be associated with the employee record. In some embodiments, a printed version of the I-9 form may be generated by the system, including the verification number. In this manner, embodiments allow employee files and records to accurately reflect the verification status of each employee (including in both physical files and electronic files), thereby reducing the risk that an employee is employed without appropriate verification. In some embodiments, the version of the I-9 form that is printed using the system is one that reproduces the layout and look of an official I-9 form, with the data fields filled in using the data provided during process 200, as well as the verification number received from E-Verify.

The process 200 of FIG. 2 may be performed on a regular basis, as new employees are hired, and as the status of existing employees changes. For example, the system 110 may continually process data of existing employees to identify situations where updated verifications may be required. In some embodiments, when employee records are identified which are associated with verification expiration dates, a series of calendar reminders may be generated and transmitted to parties associated with the employee (including the employee, one or more attestors associated with the employee, Human Resources staff, etc) to ensure that verification expiration dates are not missed. In some embodiments, details of the steps needed to re-verify an expiring employee verification may be provided in the notifications. The re-verification may be performed using the same (or similar) process as described in conjunction with FIG. 2. In one example, it is determined if a temporary work authorization is involved at 211. If a temporary work authorization is involved, then the verification process is triggered at 202. If no temporary work authorization is involved, the process may end at 213.

In some embodiments, existing employee reports may be run separately from new hire reports (e.g., the processing at 202 may be performed separately for new hires and for existing employees). In such an embodiment, an analysis may be run on verification system 110 to identify employees requiring re-verification. For example, analysis may include the identification of employees who have work authorization expiration dates in their employment data. In some embodiments, the identification of such employees may trigger a series of notifications (e.g., at 120, 90, 60, and 30 days prior to the employee's work authorization expiration date), in which the employee will be notified (e.g., via email) that their work authorization will expire on a specified date and they need to follow-up with an appropriate attestor.

In some embodiments, when the employee contacts the attestor with unexpired work authorization document(s), the attestor will log into the verification processing system 110 and search for the employee by name and once displayed, the employee will enter his/her date of birth (in the same manner as described above). For such re-verification employees, the I-9 record may be displayed with Section 3 enabled, Section 1 visible but grayed out, and Section 2 not visible. The attestor will record the document title, number, and expiration date if any to reestablish work authorization. As described above, the attestor will again be required to electronically sign and date the Section 3 entry. This information is stored with the original 19 record, and is included in the pdf version of the I-9. Under some circumstances the employee may be required to complete a Section III re-verification multiple times; in these situations the system 110 will prompt for re-verification, the attestor 105 and employee 103 will complete a new re-verification following the process outlined above, and the information is stored with the original I-9 record. The system is designed to produce pdf versions of the full I-9 which contain multiple Section III work authorization re-verifications if necessary. In situations where the employee does not follow up by the work authorization expiration date, an employer representative will follow a process to initiate termination of employment.

A number of different work situations may require such re-verification. For example, employees who initially verify their eligibility for employment by presenting a foreign passport with I-551, or an “EAD Document” (also called an I-766), a foreign passport with I-94 or I-94A, or the like. Each of these documents (and others) require different re-verification processing and scheduling. Embodiments allow the different schedules and rules to be easily and accurately tracked, ensuring that employees requiring re-verification are appropriately handled.

The process 200 of FIG. 2 may include a number of variations, including variations associated with the collection and submission of verification data by an attestor. For example, in some embodiments, a photo verification process may be performed to confirm the identity of the employee who is being verified (e.g., such as in conjunction with the user interface processing of FIG. 3B or FIG. 31). In such embodiments, a photo associated with a document presented by the employee may be compared (either electronically, using photo recognition techniques, or manually, by an attestor) to confirm the identity of the employee. A verification process may fail or be referred for further analysis in the event that a photo match is not able to be achieved with a satisfactory level of confidence. In some embodiments, the photo captured by a digital camera may be appended to the verification data associated with an employee and transmitted to E-Verify for storage and/or for further analysis. In some embodiments, a photo comparison may be made between a stored or known photo (such as from a passport, or other document) and the employee 103 and the results of the comparison may be transmitted to the E-Verify system 116 or otherwise stored in the I-9 compliance module 112.

Reference is now made to FIG. 4 where a process 400 (that may be performed by the verification processing system 110 in response to a verification response received at 210) is shown. In particular, the process 400 depicts a series of processing steps that occur under control of the verification processing system 110 in the event that a verification response received (e.g., at step 210 of FIG. 2) indicates that either the Social Security Administration (“SSA”) or the DHS could not verify the furnished information provided for an employee. In such a situation, a number of processing steps are performed under control of the system 110 that ensure that appropriate actions are taken to either resolve the verification (e.g., by providing updated or corrected information) or to terminate the employment (as the employer is unable to verify the employee's employment eligibility).

Processing begins at 402 where verification data is submitted to the E-Verify system 116 as discussed above in conjunction with step 208 of FIG. 2. A response is received at 404 indicating that the SSA or DHS initiated a “TNC” message. The system 110 captures this verification response and updates the employee verification record to indicate that an SSA or DHS TNC has been received, and a notice is triggered and sent to an investigator, requesting that the investigator initiate review of the TNC. The investigator may consult with the employee and determine, at 408, that a data correction is needed and may update or correct the information at 418. The attestor and employee are requested to provide the updated verification data at 424, and processing continues at 402 where the updated data is resubmitted at (using a process similar to that described above in conjunction with FIG. 2, step 208).

If processing at 408 indicates that the TNC cannot be remedied by a data correction (or that there was no data error to be corrected), processing continues at 410 where the investigator is prompted to consult with the employee to determine if the employee wishes to contest the TNC. If not, processing continues at 412 where the investigator interacts with the system 110 to initiate a termination process. The termination process causes a data record in the employee database 122 to be updated (indicating the employee is terminated) and continues at 414 where the system 110 retrieves the newly updated employee record and updates a status in the system 110. The status of the case is then updated to indicate a status of “Self Terminated”. The status prevents the workflow from proceeding and the verification process is completed.

If processing at 410 indicates that the employee does wish to contest the TNC, processing continues at 426 where the investigator updates a status in the system 110 to indicate such and a notice and instructions are provided to the employee. Processing continues at 428 where the status of the case is set to “pending”. The status change may trigger a calendaring item which causes the employee (and/or the investigator) to contact the appropriate agency (either SSA or DHS, as appropriate) within 8 days. If the contact is not made within the 8 day period, the appropriate agency (either SSA or DHS, as appropriate) may close the case on their end, sending a Final Non-Confirmation update status to system 110. Receipt of a Final Non-Confirmation update status triggers a prompt to the investigator to begin the termination workflow process, resulting in an update to the employee database 122, and an update to the status in the system 110 indicating the case is resolved, employment was not authorized, and the employee was terminated.

If the employee contacts the agency within the required time period, processing continues at 448 where a determination is made whether the agency authorized the employee (e.g., removed the “TNC” status). The updated status information may be retrieved from the E-Verify system by polling or contacting the system to obtain the updated data. If the TNC status was removed, processing continues at 450 and the status of the verification is set to indicate that employment was authorized and processing completes.

If the TNC status was not removed, processing continues at 452 where a determination is made whether the data should be resubmitted. If yes, processing continues at 454 and the data is resubmitted (e.g., using the process at 208 of FIG. 2). A verification response is received at 458 and further processing is performed depending on the nature of the verification response.

If processing at 452 indicates that no further submissions are desired or possible, processing continues at 460 and a determination is made whether this is a final non confirm. If so, a determination is made whether to terminate the employee and, if so, termination processing occurs at 464-474. In some situations, a determination may be made that the employee not be terminated, in which situations a case status of employee not terminated is made.

In this manner, embodiments provide detailed and rigorous workflow and processing control to ensure that TNC responses from agencies such as the SSA or DHS are properly resolved and handled, including the communication and calendaring of information to relevant parties. The result is a system and processing that reduces errors, improves compliance and ensures appropriate handling of employment matters.

FIG. 5 is a block diagram representation of a server useable as the verification processing system 110 shown in FIG. 1. The server(s) used as the verification processing system 110 may be conventional in terms of their hardware aspects.

As depicted in FIG. 5, the verification processing system 110 includes a data bus 501. The user computer 314 also includes a computer processor (CPU) 500 which is operatively coupled to the data bus 501 and which may be constituted by one or more conventional processors. The user computer 314 further includes a network interface unit 502, system memory 503, one or more storage devices 504, and an input/output controller 506, all of which are also operatively coupled to the data bus 501.

The network interface unit 502 may function to facilitate communication with, for example, other devices (such as, for example, the attestor devices 102, investigator devices 104, employee data 122, external data sources 118 and E-Verify 116). The input/output controller 506 may couple an administrator device to input and output devices (block 507) such as a keyboard, a keypad, a mouse or other pointing device, a microphone, knob or a switch, an infra-red (IR) port, a docking station, a touch screen, a display (e.g., a display screen), a speaker, and/or a printer. Thus block 507 may be taken to represent a typical one of the display module(s) or screens shown in FIG. 3.

The system memory 503 may be constituted by, for example, a suitable combination of Random Access Memory (RAM) devices 508 and Read Only Memory (ROM) devices 510.

Storage devices 504 may comprise any appropriate information storage device, including combinations of magnetic storage devices (e.g., magnetic tape and hard disk drives), optical storage devices, and/or semiconductor memory devices. At least some of these devices (and/or all or part of the system memory 503) may be considered computer-readable storage media, or may include such media.

Storage devices 504 store one or more programs (at least some of which being indicated by blocks 512, 514) for controlling CPU 500. CPU 500 performs instructions of the programs, and thereby operates in accordance with aspects of the present invention. In some embodiments, the programs may include one or more conventional operating systems, indicated by block 512 in FIG. 5. The programs may further include application programs (block 514) such as a conventional browser, a conventional data communication program and a conventional database management program. The application programs 514 may include suitable software for, e.g., notifying attestors, employees, investigators and administrators of workflow events (such as the need to respond to TNCs, the need to obtain and submit employee verification data, etc), as well as to control the receipt and processing of employee verification data. In some embodiments, the application programs 514 may also include one or more interface or API programs which allow the system 110 to transmit and receive data from the remote E-Verify system 116.

There may also be stored in the storage devices 504 other software, such as device drivers, etc.

Still further, the storage devices 504 may store one or more databases (block 516) for storing and managing the data relating to operation of the verification system 110. For example, the databases 516 may store data associated with I-9 forms, workflow processes, responses received from the E-Verify system 116, as well as status information associated with active or pending employee verification records.

Pursuant to some embodiments, the databases 516 also include rules and program code for ensuring that I-9 forms are properly completed, including the rule sets associated with ensuring that appropriate documentation is received from an employee and attestor (e.g., as described above in conjunction with FIG. 2).

In addition to ensuring that employee verification is performed in a timely and appropriate manner, the system 110 ensures that follow up actions such as the response to TNC or error messages as well as subsequent validations (e.g., for employees on a limited Visa or work permit) are performed in a proper manner.

The data display resources disclosed herein may be particularly helpful to large employers in that the displays and workflows may ensure that the employer is able to efficiently and properly comply with regulatory requirements to properly verify each employee's eligibility for employment.

The term “server” as used herein and in the appended claims, refers to standalone server computers and also “virtual servers” provided as part of the functionality of a server or other computer.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A data processing system for verifying employment eligibility, said system comprising:
an employee database, for storing a plurality of employee records each record having data associated with an employee including an employee hire date and an employee hire status;
a verification processing system for receiving information associated with at least a first employee record from said employee database and for triggering the initiation of an employee verification process based on at least one of said employee hire date and said employee hire status, said employee verification process including the notification of at least a first attestor to gather employee verification data associated with said at least first employee record;
an interface module for receiving said employee verification data and for submitting said employee verification data to a remote verification entity for verification processing, said interface module further for receiving a verification response from said remote verification entity based on said verification processing; and
said verification processing system configured to update an employment eligibility status based on said verification response and to generate at least a first workflow notification based on a result of said verification processing.

2. The data processing system of claim 1, wherein said initiation of an employee verification process is triggered if said employee hire date indicates said employee is a new hire.

3. The data processing system of claim 1, wherein said initiation of an employee verification process is triggered if said employment eligibility status indicates an employee is an existing employee for which re-verification is required.

4. The data processing system of claim 3, wherein said verification processing system further transmits at least a first notification to said employee of said required re-verification.

5. The data processing system of claim 1, wherein said initiation of an employee verification process is triggered if said employment eligibility status indicates that a status is a data correction status.

6. The data processing system of claim 1, wherein said notification of at least a first attestor includes transmitting at least one of an email and a status update to said at least one attestor.

7. The data processing system of claim 1, wherein said interface module for receiving said employee verification data further comprises:
code for generating at least a first user interface for confirming an identity of said employee, said user interface prompting an employee for personal information associated with said employee to provide a logical association as an electronic signature.

8. The data processing system of claim 7, wherein said interface module for receiving said employee verification data further comprises:
code for generating at least a second user interface for receiving employee information from said employee.

9. The data processing system of claim 8, wherein said interface module for receiving said employee verification data further comprises:
code for generating at least a third user interface for receiving an employment status of said employee.

10. The data processing system of claim 9, wherein said interface module for receiving said employee verification data further comprises:
code for generating at least a fourth user interface based on said employment status, for receiving information identifying a set of acceptable documents for proving said employment eligibility of said employee, said set of acceptable documents selected based on said employment status.

11. The data processing system of claim 10, wherein said interface module for receiving said employee verification data further comprises:
code for generating at least a fifth user interface including said employee hire date, and prompting said at least one attestor to certify said employee verification data.

12. The data processing system of claim 1, further comprising receiving image data from an image capture device in communication with said verification processing system, said at least one image capture device for capturing an image of an employee for comparison to a stored image of said employee.

13. The data processing system of claim 12, wherein said stored image of said employee is retrieved from a system operated by a third party.

14. The data processing system of claim 1, wherein verification response is a tentative non confirmation and said at least first workflow notification is a notification to an investigator device notifying an investigator of said verification response.

15. A process for verifying employment eligibility of an employee, the process comprising:
operating a verification processing system to trigger an employee verification process based on information associated with said employee;
notifiying at least a first attestor operating an attestor device of said employee verification process for said employee, said notifying including generating at least a first message by said verification processing system;
generating, by said verification processing system, a series of data entry screens for display on said attestor device, said series of data entry screens generated based on information associated with said employee and based on a employee hire status of said employee;
receiving verification data associated with said employee from said attestor device in response to said series of data entry screens;
transmitting said verification data associated with said employee from said verification processing system to a remote verification entity; and
receiving a verification response from said verification entity, said verification response causing the initiation of at least a first workflow notification by said verification processing system.

16. The process of claim 15, wherein said series of data entry screens includes a screen prompting said employee to perform an authentication process prior to display of a remainder of said series of data entry screens.

17. The process of claim 16, wherein said authentication process includes prompting said employee to enter at least a date of birth, said entered date of birth compared to employee data provided prior to said employee verification process.

18. The process of claim 15, wherein said generating said series of data entry screens based on information associated with said employee includes retrieving employee data from an employee database, said employee data provided during a hiring process.

19. The process of claim 15, wherein said trigger is based on at least one of a hire date of said employee and an employee hire status of said employee.

20. The process of claim 15, wherein said trigger is based on an employee status of said employee indicating that said employee is an existing employee for which reverification is required, wherein said trigger causes an I-9 reverification process to occur.

21. The process of claim 15, wherein said verification response is a tentative non confirmation, wherein said at least first workflow notification is a notification to at least a first investigator to review said tentative non confirmation.

22. The process of claim 15, wherein said series of data entry screens includes a screen prompting an attestor to compare at least two images of said employee to confirm a match between said two images.

23. An employee verification system, comprising:
a hiring system, for receiving employee data associated with employees, including at least an employee name, an employee birthdate, and an employee start date;
a verification processing system, in communication with said hiring system, for receiving said employee data and for causing the initiation of an employee verification process based at least in part on said employee start date, said employee verification process including providing said employee data to at least a first attestor and prompting said at least first attestor to obtain employee verification data associated with said employee data;
an I-9 compliance module, associated with said verification processing system, for generating a sequence of user interfaces for display on an attestor device operated by said at least first attestor to receive said employee verification data, said sequence of user interfaces generated based on said employee data and including at least a first user interface prompting an employee to enter birthdate authentication data, said birthdate authentication data compared to said employee birthdate from said hiring system; and
an external verification module, associated with said verification processing system, for receiving said employee verification data from said I-9 compliance module and for transmitting said employee verification data to a remote verification entity for verification processing and further for receiving a verification response from said remote verification entity based on said verification processing.

24. The employee verification system of claim 23, said verification processing system further configured to update an employment eligibility status of said employee based on said verification response from said remote verification entity.

25. The employee verification system of claim 23, said verification processing system further configured to generate at least a first workflow notification based on said verification response.

26. The employee verification system of claim 25, wherein said I-9 compliance module is further configured to generate a completed I-9 form including said employee verification data and said employee data from said hiring system.
